(19) United States
(12) Patent Application Publication
(10) Pub. No.: US 2006/0089843 A1
(43) Pub. Date: Apr. 27, 2006

(54) Programmable, interactive task oriented hotspot, image map, or layer hyperlinks within a multimedia program and interactive product, purchase or information page within a media player, with capabilities to purchase products right out of media programs and/ or media players

(76) Inventor: David Flather, North Vancouver (CA)

Correspondence Address: David Flather, 835 West 20th St., North Vancouver, BC, V7PV2B5, CA

(21) Appl. No.: 10/972,462

(22) Filed: Oct. 26, 2004

(51) Int. Cl. G06Q 99/00

(52) U.S. Cl. 705/1

(57) ABSTRACT

Described is a system and method whereby special layers, hotspots or image maps can be programmed in to media displayed through common Internet enabled media players so that users or viewers of the media can interact in a minimally obtrusive fashion with the media being shown to perform a host of tasks or actions. Such tasks or duties can take the form of but are not limited to initiating a purchase transaction, requesting more information to be sent via electronic mail and so on. In addition, special, Internet enabled (or static, non Internet/hyper linked pages) feature pages can be programmed to appear at preset time codes at any point within a media program. The purpose of such pages can be diverse including but not limited to the role of advertising or offering products for sale relating or not relating to the media program, promoting related or unrelated media programs or acting as a bridging point connecting together a series of media programs, much like an index of a book points to the chapters of the book. Such multimedia programs can be displayed on devices including but not limited to computer screens, personal organizers with wireless Internet connections or even a television screen. Users viewing media can interact with the program in viewing environments including but not limited to: Internet type connections, telecommunication (telephone, ISDN, ADSL), VSAT satellite, and other wire and wireless transmission including as well as video conferencing. The goal of the interaction is to provide a useful and minimally interruptive form of advertising, enacting the sale of a product or service or communicating information in a synchronized manner that may or may not relate to the media being played. The interaction can take the form but is not limited to sending a follow up email containing a special offer or information, or the interaction can even prompt the person(s) to initiate a purchase process for a good or service being promoted in conjunction with the media program. In other embodiments, viewers may interact with a given program by means of a plurality of options that include but are not limited to selecting an icon or banner or pressing a button on a remote control. The resulting action sequence will then be initiated, be it a request for information, a purchase activity and so on.

### REFERENCES OF PATENTS WITH RELATED TOPICS

U.S. Pat. No. 6,606,745

U.S. Pat. No. 6,766,524

U.S. Pat. No. 6,604,085

U.S. Pat. No. 6,633,850

### BACKGROUND OF THE INVENTION

The growth of the Internet and media compression technologies have now made it possible to offer multimedia programs through the Internet or via other electronic means in a fast, affordable and high quality fashion. With the introduction of multimedia programming over the Internet, comes the capabilities for 2-way communication. This allows us to now program interactive marketing right into programs that can be used to facilitate a more useful transfer of information. This also gives us the capability to purchase things right out of multimedia programs or commercials. Thus, the advertising sector stands to benefit from our developments and ways of improving communication with individuals.

Consumers can also benefit from our new technologies. They will now have the added convenience to buy products right out of entertainment, educational or other programs using our 2-way communication technologies. Consumers or viewers of such programs will also be able to request additional information via relevant links embedded directly into the relevant media or sector of media depicting a definable product or category.

### BRIEF SUMMARY OF THE INVENTION

We have utilized existing multimedia and Internet technologies and incorporated programming techniques to further enhance and enrich media programs of all types.

We accomplish this with 2 methods and means.

First, by establishing an “image map”, “layer” or “hot spot” defining a region or area within a multimedia segment, we can then program (using established languages such as JavaScript) behaviors or actions to be performed when the user interacts with such a defined area or region using some form of interaction, including but not limited to a pointing device, keyboard stroke or combination of strokes or even a voice or auditory command.

Secondly, we can also program the process and means (within currently available media player software tools) by which to display a web page, web site, file or series of pages depicting information or products relating to the media program, or information or products of a completely different nature at the end of a media program. This can also be accomplished in an infinite series of cycles, whereby any media program can be broken down into an infinite number of segments, each with its own preprogrammed web page at the end, with links embedded in such a page(s) for the user to follow and complete loading subsequent or sequential media programs, each with their own preprogrammed ending web page or file to display.

Both methods of programming (layers and the display of a file at the end of a media program) can be incorporated together in any media segment, or the two methods of programming may be deployed separately.

Both the incorporation of layers and the display of a preprogrammed interactive file at some point within a media program has the effect that when a user initiates an interactive component to perform a task, the types of tasks that can be performed include a plurality of duties including but not limited to automatically sending the user a follow up email, product in the mail etc. without interruption to the user's experience. This can be a non-obtrusive, non-offensive way of supplying the user additional related information or information relating to non-related topics that may be of interest to the user. Similarly, the system can be used to offer a product for sale related to the multimedia program. In this instance, the system prompts the user to initiate a purchase action that can incorporate information already accessible about the user and needed for a purchase transaction. This can greatly streamline the electronic purchase of a good or service, as the user may not have to enter any of their personal information details, as that can be accessed in a database if the person is viewing the media in a logged in environment or in an environment where an account has been previously established, such as in the instance of a cable television, telephone service wired or wireless) or Internet service providing environment.

### BRIEF DESCRIPTION OF THE DRAWING

FIG. 1: Image maps, layers and hotspots depicted.

FIG. 1 clearly shows media player controls in the center at the bottom that the user can use to play, pause, stop and adjust the audio of the media with. As well, there is one shaded area on each of the two upper images. These shaded areas of the images show a possible location of where the special layer, hot spot or image map can be located that when interacted with by the user, will initiate a follow up action. In the uppermost image, the desired action is denoted as an “email to be sent”. In the middle image, the shaded area over the bicycle tire is preprogrammed to initiate a purchase of the tire. Such a purchase can be completely automated as will be shown in FIG. 3. The media images may or may not be in proportion to that shown.

FIG. 2: File, web page, web site or alternate media to be displayed within the media viewer software in conjunction with the primary media program.

FIG. 2 clearly shows a product oriented page file that happens to be in the form of a web page from a web site. Depicted are several items that an individual can choose from to purchase. Underlined text form hypertext links that when interacted with by means of a pointing device, keyboard stroke or other form of interaction will initiate a purchase transaction with the user. Similarly, hyperlinks can be added to this page or subsequent pages that initiate the next segment of the media program, or a completely different program or media to view.

The media images may or may not be in proportion to that shown.

FIG. 3: Automatic purchase procedure.

FIG. 3 depicts a web page that can be preprogrammed to appear within the media player in conjunction with the media program. When the media player or media to be viewed is initiated through a login or signup process, the user's information can be retained throughout the session through the use of an electronic cookie. This information can then be used as a unique identifier to facilitate the one step process of purchasing a product or service by the individual that initiated the media player and media. This is accomplished in much the same fashion that an individual logs in to an electronic commerce web site and begins shopping. They only enter their information once and then add products or services to the shopping cart. In the instance depicted by FIG. 3, all of the user's pertinent purchase details, shipping address etc. happen to be connected to his login procedure at the time the media player and/or media were initiated. Thus, all the individual has to do is choose which item(s) he wants and the system will automatically generate the order based on the account information parlayed and referenced in the electronic cookie of the login session.

### DETAILED DESCRIPTION

Overview

Existing two-way electronic communication technologies have been utilized applicable to Internet, cable television, telephone and/or other existing technologies (and will make them forward compatible with future or yet undeveloped electronic communication technologies) and they have been modified and improved to offer a secure and convenient way for people to receive more information or purchase products or services that are being shown within a media player environment playing some form of electronic media program or entertainment. This allows users to interact with the media electronically to solicit more information on products being shown to them or featured in the media program they are watching.

The improvements detailed in this patent also allow individuals to shop for and buy products of interest featured in the program (or products not featured in the program) they are watching easily and without the need to keep entering their payment details or address information, as this information will already be contained in a database record emanating from a login procedure and/or a session cookie containing electronic identifiers unique to the user. The information will already be accessed in the database as viewing of the media player with the described interactive product purchase (and additional informational sending components) will require a user to be “logged in” to a database storing their personal information. At some point prior to accessing the media, each individual that “logs in” will have at one time submitted the information pertinent to identifying such individual. This is commonly done through an electronic membership signup process or some similar process.

### DETAILED DESCRIPTION

Specifics

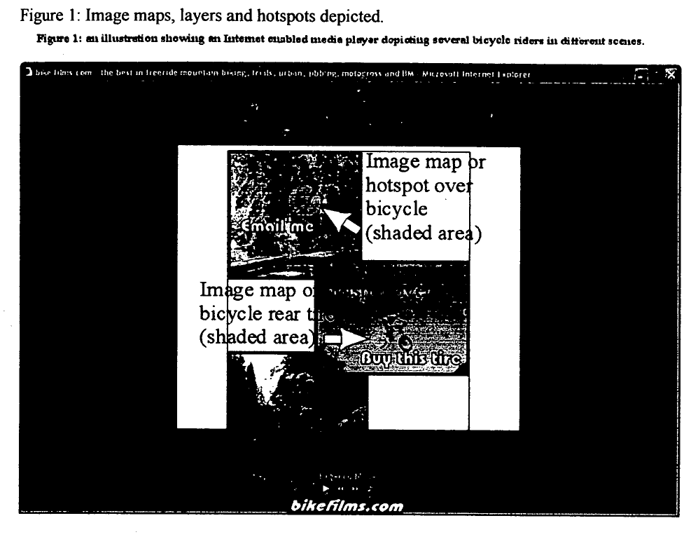

Programmable, interactive task oriented hotspot, image map, or layer hyperlinks within a multimedia program and interactive product, purchase or information page within a media player, with capabilities to purchase products right out of media programs and/or media players.
1. The programmable hotspots, image maps or layers can be described as an area defined by the creator of the media and interactive components to be utilized during the program. The area can take any shape, size or form up to and including the entire surface area of the area used for viewing the media. There can in fact be one or many defined hotspots or image maps within the viewable area of the media player. In the case of multiple hotspots they may even overlap one another. The image maps, layers or hotspots can be programmed to be active or inactive at any point in time during the program. What may be a defined and dedicated area or hotspot in one section of the media program to hyperlink with product A could be programmed the very second it goes inactive to create an active hyperlink to product B. Each hotspot, layer or image map may have its very own electronic action associated with it as well as methods of enacting the action. Electronic actions can include but are not limited to sending an electronic email or message, opening a new screen in the foreground that may contain additional information or purchase options and could even include sending data to the database the user logged in with to collect and compile user preferences.
   For an illustration of this please see FIG. 1. The reader will note in FIG. 1 the “gray crosshatched” circular areas on two of the bicycles as pointed out by the yellow arrows. These regions can actually be programmed to perform completely separate functions during the same time sequence, overlapping time sequences or completely different time sequences.
   In the upper instance the reader will see the words “Email me” in white and black letters. The corresponding electronic action to be performed in this instance is to send the individual watching this media a follow up email that would contain all the pertinent details about the bicycle being ridden in the scene (for instance). That email could also contain a special discount if the individual buys the bike that day. Any sort of information (i.e. product or technical related) could be presented in the email as well as hyperlinks showing other places to buy the bicycle.
   In the lower instance the reader will see the words “Buy this tire” in white and black letters. The corresponding electronic action to be performed in this instance is to allow the individual watching this media to buy the brand or style of tire being used by the rider in the scene. If the individual watching the media for instance passed his mouse pointer over the tire (one of many possible user initiated actions including but not limited to a computer mouse pointing device), it would automatically open a purchase screen. That screen could contain all the sizes and styles that brand of tire is available in so the individual can easily pick the right one if it happens to be something that commonly comes in several sizes, colors etc (like tires but of course not limited to tires). This purchase screen action prompted by the individual and their interactive communication tool could already be pre-populated with the individual's shipping address referenced from the data stored in the database the individual used to login to view the media in the first place (or through the use of an electronic cookie), facilitating an easy and very rapid purchase. In addition, if the user of the media has indicated they wish to participate in some manner with an automated billing and invoicing protocol connected to the media provider and the service account, the user would not even need to enter any payment details, as that information could also be referenced in the database or contained within an electronic cookie.
   In both of the instances or examples listed in conjunction with FIG. 1 the interaction initiated by the user was simply passing the pointer of their interactive communication tool (in this case a computer mouse) over the hotspot area. Of course other interactive communication tools could be deployed (including but not limited to infrared remote control units, voice commands etc.) to facilitate the same activation of the electronic action. Similarly, other actions of the interactive communication tool could be programmed to activate the electronic hotspot or image map action. In the case of a computer mouse, there are many possibilities including but not limited to depressing one or more of the mouse buttons while the mouse pointer is over the defined hotspot, layer or image map.
   Additionally, the explanatory text such as “Email me” or “Buy this tire” as shown in FIG. 1 could be an actual “layer” of media or text and could also provide the same electronic task functionality as the “email me” or “buy this tire” hotspots located over the products themselves, or they could perform different tasks.
2. The programmable hotspots, layers or image maps can be programmed to appear with pre-defined electronic action duties just as easily as they can be programmed to appear at a pre-set time code during the program and remain active only as long as desired or as long as they still relate to the media being shown behind the hotspot (as well as the corresponding desired electronic action to be initiated relating to the hotspot, layer or image map and the media on display). Thus, the interactive hotspot may only appear for 1 or 2 seconds but could of course be initiated at any time during the media program or presentation and could even run the entire course of the program. This functionality has no dependencies on variables. Rather, how, when and where the hotspots work is entirely up to the programmer and how they choose to synchronize the actions with events in the media program.
3. The media player providing the media program may be automatically paused when the individual viewing a media program initiates a hotspot action (such as but not limited to the action of bringing up a new screen). In addition, the individual may choose to manually “pause” the media player when the individual sees something they like prior to initiating the interactive action with the hotspot, layer or image map so that upon completion of the tasks with the new screen, they may resume viewing their media just where they left off.
4. The programmable hotspots can also be programmed to purchase a product with as few as just one single action with the interactive communication device and no new screens appearing. This could be accomplished in one of several ways that include but are not limited to the following two examples:
   First, if the party(s) providing the media program and media player interface offer their customers or members a prepaid account or some form of credit account, the individual would be able to draw down on that account through purchases made of products or services offered before, during or after the media program. This would be made possible by electronic database references made by the electronic action initiated by the user that would collect from the database all the data on the individual (as they would be logged in prior to viewing) including but not limited to data elements such as name and shipping address, account balance available to purchase products or services with, while accessing details pertinent to the purchase associated with the hotspot including but not limited to information such as price, taxes (if applicable) and shipping costs.
   Second, if the party(s) providing the media program and media player interface offer their customers or members the option of automatic billing of their purchases through a pre-determined arrangement with their service provider, the individual would be able to purchase products or services offered before, during or after the media program. This would be made possible by electronic database references made by the electronic action initiated by the user that would collect from the database all the data on the individual (as they would be logged in prior to viewing) including but not limited to data elements such as name and shipping address, service provider credit account details, while accessing details pertinent to the purchase associated with the hotspot including but not limited to information such as price, taxes (if applicable) and shipping costs. This automated payment process may also deploy the use of electronic cookies.
      a. The login process (if auto-billing with a service provider) may be initiated when the user activates their electronic device and establishes electronic communication with the service provider. Some form of login is required to establish the identity of the user so that purchases made by the user may be correctly confirmed in an established or existing account. This login is also necessary to facilitate the proper delivery of the product or service to the rightful user, be it an electronic product or service or a real, physical, tangible product. In some instances, the login may be automatic simply by establishing the connection to the service provider (i.e. such as an internet or cable service provider).
      b. A second means of initiating the login process (if auto-billing with a service provider) is “user initiated”. In this instance, the user must enter an activation code or password of some form to establish the electronic communication. In this login process the user electronically contacts the service provider. Once the link is made, the user is prompted to input their predetermined code or password. A reference check may then be done by the service provider to records on file and if a match is made, the service can be initiated. During the time service is being used, the service provider has record of the unique identifiers of the user relating to their service account and thus when the user initiates a purchase transaction or request for services, they can be automatically billed to the user's service account. In this case the service provider would then forward payment on behalf of the user to the “product provider”. Conversely, the service provider may simply act as a middleman, and simply provide the communication and payment processing for the product provider according to a pre-determined arrangement. In this instance, payment or credit information held on file by the service provider is used and the service provider may not need to receive or hold the funds or fees payable emanating from the purchase or transaction.
5. The media player technology that the processes described in this patent apply to include but are not limited to Internet enabled browser screens compatible with Internet Explorer as well as other popular Browser platforms for both Personal Computer (PC based) and Apple/Macintosh based computer systems. Furthermore, they may be built on existing computer media player technology and will be forward compatible for new or undeveloped computer media player technologies capable of delivering and displaying multimedia programs.
6. The media player technology that the processes described in this patent apply to will work irregardless of the method of program delivery, be it commonly known present day delivery means including but not limited to cable television, Internet, satellite transmission or any other wired or wireless means of delivering information.
7. The processes described in this patent that apply image maps, layers or hotspots within a media player skin or layer to allow interactive actions, can accomplish many diverse tasks. Some of these tasks include but are not limited to sending an email to the individual initiating the interaction, generating a purchase order as a result of a “buy” action or instruction of a predetermined product or service that can then be printed and mailed to a buyer or a service provider, creating a purchase page (including within a new screen that opens up) that may show one or many products or services available for purchase and so on. Many of the electronic interactions can be programmed in such a manner that the individual viewing the media program does not have to be interrupted viewing his media program whatsoever.
   The processes for purchase outlined herein may not even involve the electronic transfer of funds at time of purchase (i.e. a non-ecommerce transaction). For example an individual may decide he would like to buy the tire depicted in FIG. 1. When he uses his interactive communication tool to enact the purchase action with the hotspot or image map, data about the product would be pulled from the database (this may even be the same database he logged in with to activate the media player and watch the media program) along with all his personal details required for shipping a product. These two “packets” of data (i.e. his mailing address and the tire price, taxes and shipping costs) could all automatically fill an invoice form. This invoice could automatically be printed out and mailed (or faxed) to the individual. Upon receipt of the invoice, the individual would do as he would do with any invoice, fill out a check for the amount of the invoice and mail it back to the appropriate vendor, which may or may not be the media provider. Once payment is received, the vendor would then ship out the product.
   Similarly, the processes I have developed that apply image maps, layers or hotspots within a media player skin or layer to allow interactive actions could be used to generate an invoice to be delivered electronically via email. Upon receipt of the invoice, the individual would do as he would do with any invoice, fill out a check for the amount of the invoice and mail it back to the appropriate vendor, which may or may not be the media provider. Once payment is received, the vendor would then ship out the product.
   Furthermore, the processes I have developed may also be applied to products or services that may be offered for free, for example an electronic newsletter subscription.
8. The media delivered with the media player technology can include but is not limited to information, promotions or campaigns, entertainment, educational content and so on.
9. The technology and electronic actions described in this patent will work on all media players and is in no way dependent on the payment options of the media programs.

Also developed and described in this patent is another interactive process within a media player. This can be described as an “interactive feature page (or pages)” that can be deployed in any media program at the beginning of the media program, end of the media program or any point in between. This page can be fully html driven (or any commonly accepted scripting language used in Internet applications) complete with images, text and even multimedia components such as motion and sound.

The purpose of this page is to offer in one place a grouping of products or services that were featured or are to be featured during the media program. This page may even consist of several pages linked together within the media player in the event that many different products or services are included in the media program (or entirely different products/services not related to the media program). Similarly, allowing multiple interactive feature pages to be hyper linked together will allow products or services with multiple variations (including but not limited to size, color or flavor) to be fully displayed so the individual viewing may easily find the exact product or service he or she seeks.

Furthermore these interactive feature pages may be used to promote the purchase of products featured in the media program (or entirely different products/services not related to the media program) or could simply be used primarily to serve as a source to obtain more information. They can also be fully programmed to act much like what is commonly known as a television commercial with motion and sound and an option to buy right out of the commercial at any point.

Two examples can briefly be described to demonstrate a purchase oriented “interactive feature page” within the media player.

### FIRST EXAMPLE

### Purchase Oriented

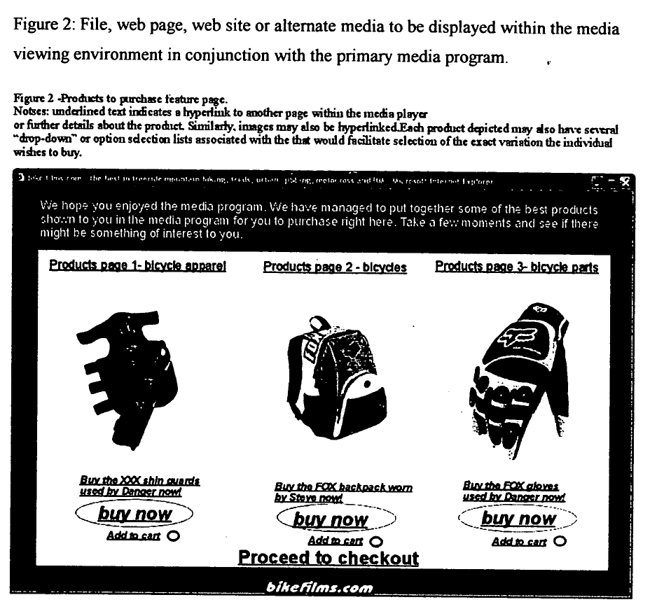

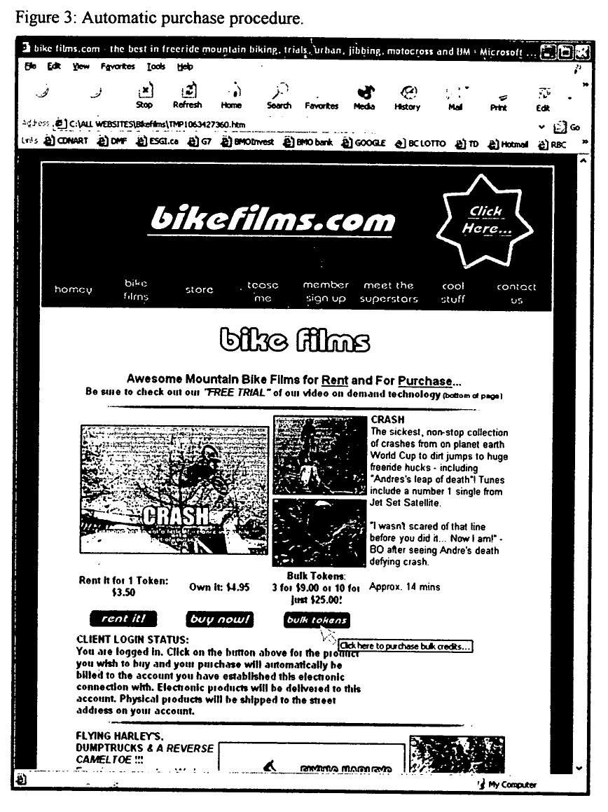

An individual watches a media program featuring athletes riding bicycles. At the end of the media program the credits appear and during the last credit, the media program maker may or may not insert a message to the effect of “Be sure to check the pages of products featured in this film that will appear momentarily . . . ” so that the individual viewing the program knows that there is something additional that will appear on the screen. Then the actual media program ends and the page depicted in FIG. 2 appears (titled “File, web page, web site or alternate media to be displayed within the media viewing environment in conjunction with the primary media program.”). FIG. 2 clearly shows a single screen of what the individual may see on his display screen within the media player environment after the media program ends. Within the confines of the white area the reader will see three underlined text areas at the top of the white area depicting hyperlinks to other interactive feature pages. If the individual viewing the media program were to perform some form of task with their interactive communication tool (such as selecting one of those underlined text areas and clicking on it with their computer mouse) it would take them to another interactive product feature page via the hyperlink embedded on the underlined text area.

Also, the reader will note there are 3 distinct bicycling apparel items shown within the white area. If the individual viewing the media program were to desire to purchase one or more of those items, they would simply need to use their interactive communication tool (such as a computer mouse) to simply select the underlined link corresponding to the product(s) they wish to purchase. By selecting the link, any number of commonly used electronic actions could be initiated. The product could be simply added to a shopping cart system (complete with the details pertinent to the selection) by having the individual select one or all of the small, gray, circular selection buttons commonly known as “radio buttons”. This would allow the individual to move to other pages to choose more products to buy within the interactive feature pages of the media player or decide that they are finished shopping in which case they would need to select the “Proceed to checkout” underlined hyperlink. Also, if the product were very detailed, by selecting the hyperlink associated with the product, the user could be taken to an interactive product feature page dedicated to just that product with a more detailed description and many selection options for variations of the product. These are but two examples of the electronic actions initiated by the abovementioned hyperlinks but there are of course many other actions that could be performed.

In addition, these products could all be tied in to a database able to communicate with the database used for login that enables the media programs. The individual buying the product may not even need to enter any information during the whole process if they have credit card information on file with the database, or if they have a positive “credit balance” or if an auto-pay system has been enacted with the media provider or the individual's service provider.

### SECOND EXAMPLE

### Information or Education Oriented

In this example an educational media program has been prepared for children to learn about spiders. There are many spiders featured in the media program and as the media program ends, an interactive feature page appears within the media player. This informational feature page may contain several images of “classes” of spiders featured in the media program, all (or some) with hyperlinks to other interactive feature pages. The individual that viewed the media program may then select the hyperlinks with their interactive communication tool for the classes of spiders they would like to know more about. The electronic action that results from this interaction could include but is not limited to sending the individual an email with more information (by referencing the database they are logged in to in order to draw up the correct email address) or the individual could be taken to a more detailed interactive product feature page that perhaps explains in more detail one particular spider such as the poisonous “black widow” spider. In addition, the interactive feature page could contain topics completely unrelated to the media program shown, or could contain some information relating to the media program shown and some additional, unrelated information.

Definition Notes:

Note: credit card, bankcard, payment or credit information of the user, or card used for electronic transactions can be used interchangeably.

Note: “product provider” relates to a company or entity that is providing a service or product to a user.

Note: “electronic cookie” is a term used to describe a temporary, permanent, static or dynamic data file that is sent from one electronic device to another electronic device (such as a user's computer) and can be utilized for a plurality of duties including but not limited to facilitating and verifying user login procedures, facilitating and verifying user access to certain products or services, facilitating and verifying user preferences or settings, aiding in an electronic commerce transaction and so on.

Note: a “media provider” relates to a company or entity that has a media program delivery system that uses an Internet enabled media player.

Note: a “service provider” may provide both the electronic communication means and technology as well as actual products or services. Thus, a “service provider” can also be a “product provider”. Conversely, a “service provider” may also act as an agent or middleman for a “product provider” and simply assists the product provider in providing a convenient procedure for a user to access and pay for products or services. A service provider can include but is not limited to a utility company, a cable or Satellite TV provider, a telephone company or an Internet Service Provider company.

Note: Visual device may apply to a computer, television monitor, telephone screen, PDA or personal electronic organizer, or other electronic device capable of 2-way communication and capable of displaying visual, auditory or electronic data or combination thereof

Note: “user” refers to the end user or ultimate recipient or consumer of products and/or electronic services.

Note: “logged in” or “login” or “logs in” means the process whereby an electronic connection is made (between a service provider providing electronic data and a user that is able to then receive the electronic data) and through the use of “data or customer identifiers” relating to data stored about the user or customer is referenced in a 2-way manner at either end of the connection and verified by the service provider. In Internet technologies, this process is often referred to or defined as the use of a “cookie” which may be an electronic packet of data that resides on the user's end or device and is referenced and validated on the service provider's end, to perform a plurality of duties including but not limited to authenticating that the user is a valid user and allowing the service to be provided. In this case, this “logged in” status allows the user to purchase items and have them billed to the service provider whom then in turn will bill the user. Conversely, the service provider may bill the user directly on behalf of the party providing the product or service via credit card or other financial information that may be on file for the service account.

Note: The “service address” or “account” can refer to and is not limited to the following common informational items supplied or acquired about the user or individual:

Name,

Billing Address for an account,

Shipping or Service address if different than billing address

Phone/fax numbers

Postal code

City or country

Credit card number on file

Credit card expiry date of card on file

Security numbers on credit card

IP address of host or client computer

Web site address where transaction is taking place

Email address

Time and or date stamp at time of transaction

Note: Internet can also be used interchangeably with “any means of electronic communication” and can include but is not limited to telephone communication or broadcast media and can also apply to wireless communication and satellite communication technologies. This applies to technologies available today as well as future or yet undeveloped electronic communication technologies as well.

Note: Internet and web or web page can be used interchangeably.

Note: product, service, information and entertainment are all phrases that may be used interchangeably or together.

Note: “hotspots” and “image maps” refer to a shape, region or some defined area that creates a “layer” that will be placed over some other image or media—much like layers on a cake. These hotspots, layers or image maps can be programmed with hyperlinks or electronic commands so that when a user passes an interactive communication tool like a computer mouse pointer (a computer mouse pointer is an example only as there are many other such devices or processes that can achieve the same thing) a number of tasks may be performed that may include but are not limited to sending an electronic email message, opening another media player screen to display additional information, opening another internet browser platform window, adding a product to a shopping cart (or order list) or other electronic tasks.

Note: “layer” refers to what web site designers would refer to as a level on the page upon which and image or something may be placed over or under an existing image or media. An example of an iced cake helps to explain this. After the cake is baked, it could be iced with dark chocolate frosting completely covering the cake loaf below from eyesight. The icing would in this case be the first layer and the cake loaf would be the second layer. Alternatively, the cake could be partially covered on the top revealing parts of the top of the cake loaf on the second layer. Yet another way the cake could be frosted is with a “transparent layer” of clear glaze. In this fashion, there would still be a first layer of glaze but because it is clear, you would still be able to see the cake loaf underneath as if there was no layer covering the cake loaf.

Note: “electronic delivery media stream” may refer to any type of motion picture image, multi-media presentation or show or music being delivered for auditory and visual enjoyment or learning by a user. Examples could include but are not limited to a movie, a sportscast, a live streaming broadcast, a music video and so on.

Note: “interactive communication tool” can be described as a device that allows a user to interact with media being displayed to him visually. The following is a list of some examples of such a device but the definition is not limited to this partial list: a computer mouse, a computer keyboard, a touch-screen display panel, an auditory command and receiver, a laser or infrared pointer and so on.

Note: “checkout page” refers to the final step in an electronic commerce procedure whereby a user or individual normally enters payment details in a secure socket layer (SSL) environment that encrypts the data such as credit card number with expiration before sending the sale details electronically for processing.

Note: media program can loosely be defined as any visual and/or audio entertainment that can be delivered through the media player. Such entertainment may include but is not limited to movies, music videos, educational programs, news and so on.

Note: feature page refers to a single screen displayed within the confines of the media player.

Note: the processes described herein are not dependent on the type of visual display device and can easily include but are not limited to visual display devices such as computer monitors or displays, televisions, personal electronic organizers, telephone equipment visual displays and so on.

Note: media player for the purposes of this patent can be described as commercially available (or privately made) software applications compatible with computers or electronic devices that are capable of connecting to the Internet and capable of displaying media types including but not limited to pictures, motion, sound, text and so on.

Note: “media player” and “media player environment” may be used interchangeably.

Note: This Application for Patent may be combined in whole or in part with either or both earlier Provisional Application's for Patent titled “Interactive Media Viewer with email follow up and special security features” Dated Jul. 20, 2003 and the one titled “Automated billing procedure for Internet purchase transactions tied in to the Internet, television or telephone account that is providing the electronic connection” dated Sep. 12, 2003. The two aforementioned Provisional Applications for Patent were both submitted by Dave Flather.

1. The process and method whereby a transparent layer, semi-transparent layer or other layer is inserted over an electronic delivery media stream so as to define a “hotspot”, image map, hyperlink area or region that relates to the whole or to the part of an image or media program, product or service being shown within an Internet connected media player environment so that when an individual viewing the media or entertainment in an Internet connected media player environment (whether logged in or not), the individual will be able to interact with some form of interactive or pointing device (including but not limited to interactive methods such as a computer mouse, a touch screen display or voice commands). Such interaction by the individual or user with the image maps, layers or “hotspots” that form a skin or layer overlaid over the media will enable can perform a plurality of tasks including but not limited to the task of sending an electronic follow up email message to be electronically delivered to the corresponding email address listed in the database record that forms a part of the individual's unique profile or data set.
An example of this would be a small icon that would appear over the wheel of a car being shown on the screen as a part of a commercial advertisement or as a part of a media program such as a movie. The individual viewing the car onscreen would see the icon and could use their computer mouse to click on it, pass over it etc. to enact some additional electronic information to be provided about the wheel of the car shown. Such interaction could even lead to a new screen appearing in which the individual could buy the wheel right out of the commercial or media program he is watching.
An icon may not even need appear visually to the eye, as the electronic hotspot or image map may form a completely transparent layer or skin so as to not distort the main image behind, while still providing a programmed link that can send an email to the individual's email address. In such instances, users of the media would be informed ahead of time that there are layers over definable objects or regions within the media program that when interacted with, will cause a subsequent event.
The functionality of this process that I seek protection on could also be tailored or customized so the individual does not even need to enter his payment details such as credit card number if the database information shows that the individual has opted in to an auto-pay or auto-bill program whereby the product or service they interacted with is automatically billed to their service account or through the company that is providing the electronic connection for data or media transfer on their visual device (their service provider). Users of the system could even be extended credit and pay for the purchases by check or other means from invoices to be delivered at a later time.
I also seek protection on the means of these processes. These processes can be facilitated through commonly accepted computer programming languages and techniques including but not limited to the use of electronic cookies and/or JavaScripts.

2. The process and method whereby a transparent layer, semi-transparent layer or other layer is inserted over an electronic delivery media stream so as to define a “hotspot”, layer, image map, hyperlink area or region that relates to the whole or to the part of an image or media program, product or service being shown within an Internet connected media player environment so that when an individual views the media or entertainment in said Internet connected media player environment, said individual will be able to interact with some form of interactive or pointing device (including but not limited to items such as a computer mouse or even a touch screen display). Such interaction by the individual or user with the image maps, layers or “hotspots” that are a skin or layer overlaid over the media will enable a plurality of duties to be performed including but not limited to the creation/appearance of a new screen or purchase page (while leaving the original screen with media viewer functional in the background) with purchase information and options that relate specifically to the product or service that the hotspot refers to. Many or all of the necessary details (these details may be referred to as fields) can already be pre-populated with data that forms a part of the user's unique profile or data set drawn up from the database that was accessed during an automatic or manual login or sign up procedure.
An example of this would be a small icon that would appear over the hat a man is wearing on the screen as a part of a commercial or as a part of a media program such as a movie. The individual viewing the man in the hat on-screen would see the icon and could use their computer mouse to click on it, pass over it etc. to enact a new screen appearing in which the individual could buy the hat right out of the commercial or media program he is watching. The individual may also be able to select the size or color or even style of hat as a part of the process. Once the purchase is completed the individual could resume watching the media in the background by closing off the screen used to facilitate the purchase.
An icon may not even need appear visually to the eye, as the electronic hotspot, layer or image map may form a completely transparent layer or skin so as to not distort the main image behind, while still providing a programmed link that can display new information or open a new screen that displays more information or an opportunity to electronically purchase the good or service.
The functionality of this process I seek protection on could also be tailored or customized so the individual does not even need to enter his payment details such as credit card number if the database information in their database records show that the individual has opted in to an auto-pay or auto-bill program whereby the product or service they interacted with is automatically billed to their service account or through the company that is providing the electronic connection for data or media transfer on their visual device (their service provider).
I also seek protection on the means of these processes. These processes can be facilitated through commonly accepted computer programming languages and techniques including but not limited to the use of electronic cookies and/or Java Scripts.

3. The process and method whereby as outlined in 1 and 2 above, the “hotspots”, “layers” or “image maps” can be programmed to perform a variety of tasks or actions including but not limited to sending an email to the individual's email address, opening a new screen that displays more information and so on.
I also seek protection on the means of these processes. These processes can be facilitated through commonly accepted computer programming languages and techniques including but not limited to the use of electronic cookies and/or Java Scripts.

4. The process and method whereby within a media player environment's viewing area a “special interactive product and/or information page or screen” appears at some point during the program a user is watching. This special page may appear at the beginning or at the end of the program or at any point between the start and the end of the program.
This interactive product and/or information page or screen may be used for multiple purposes at the same time (for instance when activated at the end of a media program). In such an instance, it can be used to provide a link between a series of media programs, whereby the page offers both information and/or links to subsequent segments of the program when a program is broken into a series or number of episodes. The links to additional media programs may also be used to link to related or unrelated programs or media that do not form a part of the series being viewed.
The special interactive product and/or information page or screen can also contain descriptions and/or images of products or services.
This special interactive product and/or information page or screen may include products and/or services to be bought right from this page which when a user initiates a purchase, he would automatically be taken to a secured “checkout page”.
This special interactive product and/or information page or screen may also include products and/or services that can have more information sent to the user by simply having the user interact with the page to solicit a follow up email for example. This may be accomplished with some “interactive communication tool” including but not limited to a computer mouse, a touch screen display or auditory command.
The special interactive product and/or information page or screen could be fully multi-media enabled itself capable of showing motion and playing audio.
